(19) United States
(12) Patent Application Publication
(10) Pub. No.: US 2008/0211659 A1
(43) Pub. Date: Sep. 4, 2008

(54) Apparatus and method for synchronizing alarm in fault management system

(75) Inventors: Seung-Soo Lee, Suwon-si (KR); Jae-Hong Park, Suwon-si (KR)

Correspondence Address: DOCKET CLERK, P.O. DRAWER 800889, DALLAS, TX, 75380, US

(73) Assignee: Samsung Electronics Co., Ltd., Suwon-si (KR)

(21) Appl. No.: 12/006,465

(22) Filed: Jan. 3, 2008

(30) Foreign Application Priority Data
Jan. 3, 2007 (KR) 2007-0000527

(51) Int. Cl. G08B 29/00

(52) U.S. Cl. 340/506

(57) ABSTRACT

An alarm information synchronization in a fault management system is provided. An alarm sending apparatus includes a confirmer for checking whether a sync request message is received or not; a controller for providing one or more alarm information to be synchronized and a sync session identifier to a generator; the generator for generating one or more sync trap messages including the sync session ID; and a communicator for sending the message generated at the generator.

### CROSS-REFERENCE TO RELATED APPLICATION(S) AND CLAIM OF PRIORITY

This application claims priority under 35 U.S.C. §119(a) to an application filed in the Korean Intellectual Property Office on Jan. 3, 2007 and assigned Serial No. 2007-0000527, the disclosure of which is herein incorporated by reference.

### TECHNICAL FIELD OF THE INVENTION

The present invention relates generally to a fault management system. More particularly, the present invention relates to an apparatus and a method for synchronizing alarm information between an alarm sender and an alarm receiver in the fault management system.

### BACKGROUND OF THE INVENTION

A system constituted using a plurality of devices, such as a communication system, includes a fault management system to identify faults of the devices and handle the faults. The fault management system includes a plurality of alarm senders 110 through 110-N and an alarm receiver 120 as shown in FIG. 1. Herein, the alarm is a signal generating based on an occurrence and a release of an error condition. The alarm senders 110 are various devices in the system. The alarm sender 120 collects and processes fault information from the alarm senders 110-1 through 110-N.

Mostly, the fault management system adopts a Simple Network Management Protocol (SNMP) to exchange the alarm information. The SNMP provides basic functions of ‘GET’, ‘SET’, ‘TRAP’, and so on. The ‘GET’ operation is used to retrieve alarm information recorded in the alarm sender 110. The ‘SET’ operation is used to change the setting of the alarm sender 110. The ‘TRAP’ operation is used to send the alarm about the alarm sender 110 to the alarm receiver 120. Herein, a message carrying the alarm information in the ‘TRAP’ operation is referred to as a trap message.

Using the ‘TRAP’ operation, the alarm senders 110 and the alarm receiver 120 exchange the alarm information with each other. However, the ‘TRAP’ operation is asynchronous. Accordingly, the alarm information transmitted from the alarm senders 110; that is, the trap message is likely to be lost. When the trap message is lost, the alarm receiver 120 checks the entire alarm information recorded to the alarm senders 110 by performing the ‘GET’ operation. However, frequently, because of limitations on the protocol or a plurality of alarm events, the alarm receiver 120 may not check all of the alarm information recorded to the alarm senders 110 using the one-time ‘GET’ operation. To check the entire alarm information, the alarm receiver 120 iterates the ‘GET’ operation.

To check the entire alarm information by iterating the ‘GET’ operation, it is necessary to assume that the alarm information does not change at all during the iterative ‘GET’ operations. However, such an assumption can not be guaranteed because the system is not able to control the events of the error occurrence and the error release. Therefore, the accuracy of the alarm information synchronization using the ‘GET’ operation is scarcely ensured. In other words, if the alarm information is changed in the synchronization, the alarm information between the alarm senders and the alarm receiver are still inconsistent after the synchronization.

### SUMMARY OF THE INVENTION

To address the above-discussed deficiencies of the prior art, it is a primary aspect of the present invention to substantially solve at least the above problems and/or disadvantages and to provide at least the advantages below. Accordingly, an aspect of the present invention is to provide an apparatus and a method for guaranteeing reliability of alarm information synchronization between an alarm sender and an alarm receiver in a fault management system.

Another aspect of the present invention is to provide an apparatus and a method for synchronizing alarm information using a sync trap message in a fault management system.

The above aspects are achieved by providing an alarm sending apparatus in a fault management system. The alarm sending apparatus includes a confirmer for checking whether a sync request message is received or not; a controller for providing one or more alarm information to be synchronized and a sync session identifier (ID) to a generator; the generator for generating one or more sync trap messages including the sync session ID; and a communicator for sending the message generated by the generator.

According to one aspect of the present invention, an alarm receiving apparatus in a fault management system includes a generator for generating a sync request message; a communicator for sending the sync request message; a confirmer for confirming one or more sync trap messages which comprise a sync session ID; and a controller for updating alarm information using the one or more sync trap messages.

According to another aspect of the present invention, a synchronization method of an alarm sender in a fault management system includes checking whether a sync request message is received or not; confirming one or more alarm information to be synchronized and sync session ID information; and sending one or more sync trap messages which comprise the sync session ID.

According to yet another aspect of the present invention, a synchronization method of an alarm receiver in a fault management system includes sending a sync request message; checking whether one or more sync trap messages comprising a sync session ID is received; and updating alarm information using the one or more sync trap messages.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a diagram of a simplified structure of a general fault management system;

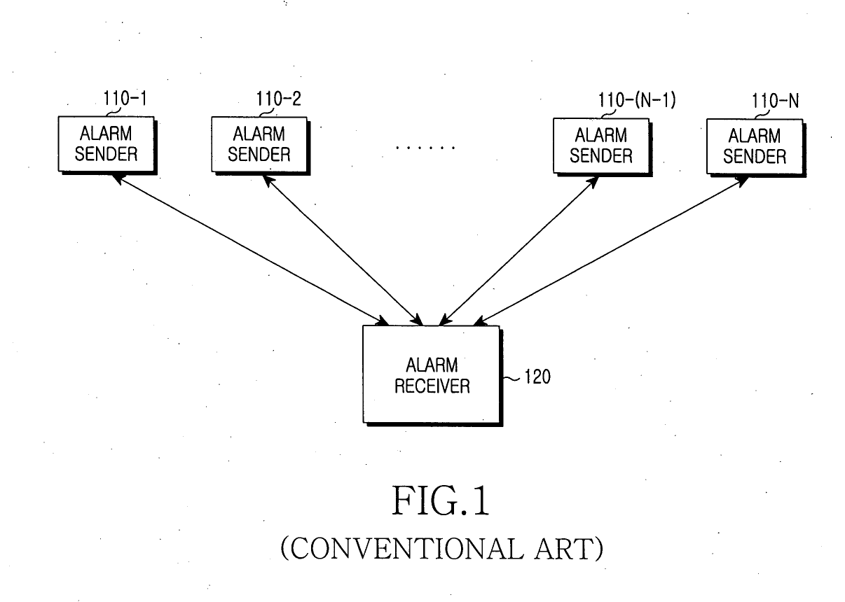

FIG. 2 is a block diagram of an alarm sender in a fault management system according to an embodiment of the present invention;

FIG. 3 is a block diagram of an alarm receiver in the fault management system according to an embodiment of the present invention;

FIG. 4 is a flowchart of a synchronization method of the alarm sender in the fault management system according to an embodiment of the present invention;

FIG. 5 is a flowchart of a synchronization method of the alarm receiver in the fault management system according to an embodiment of the present invention; and

FIG. 6 is a diagram of signal exchanges between the alarm sender and the alarm receiver in the synchronization of the fault management system according to an embodiment of the present invention.

### DETAILED DESCRIPTION OF THE INVENTION

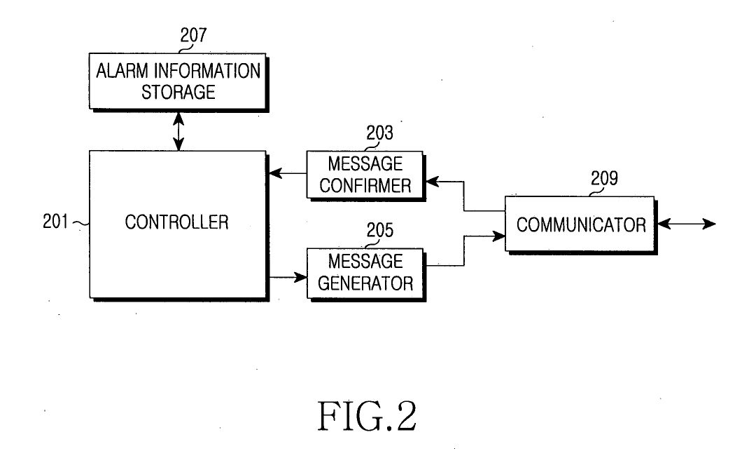

FIGS. 2 through 6, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged fault management system.

The present invention provides a technique for synchronizing alarm information between an alarm sender and an alarm receiver in a fault management system. It is assumed that the system adopts a Simple Network Management Protocol (SNMP) to exchange alarm information. Note that the present invention is applicable to systems using other protocols.

FIG. 2 is a block diagram of an alarm sender in a fault management system according to an embodiment of the present invention.

The alarm sender of FIG. 2 includes a controller 201, a message confirmer 203, a message generator 205, an alarm information storage 207, and a communicator 209.

The controller 201 controls overall operation of the alarm sender. For example, the controller 201 controls to manage alarm information and to send the alarm information to an alarm receiver. Particularly, when the message confirmer 203 confirms a synchronization (sync) request message, the controller 201 controls the message generator 205 to generate a sync response message. In doing so, the controller 201 provides the message generator 205 with information relating to the number of alarm information to be sent and a sync session identifier (ID). Herein, alarm information to be sent are the one or more alarm information which have been stored when the sync request message is received. The controller 201 restricts the transmission of a trap message about an alarm occurring in the synchronization, and controls to send the trap message after the termination of the synchronization. Herein, the transmission of the trap message is limited so as to prevent the alarm information from changing in the process of the synchronization.

The message confirmer 203 confirms a message received from the alarm receiver. In this embodiment of the present invention, the message confirmer 203 confirms the sync request message received from the alarm receiver and informs the controller 201 of the reception of the sync request message. The message generator 205 generates a message to be sent to the alarm receiver. Particularly, the message generator 205 generates a sync response message and a sync trap message. The sync response message includes information relating to the number of sync trap messages to be sent and the sync session ID. In other words, the sync response message informs the alarm receiver of the sync session ID included in the sync trap message and the number of the sync trap messages to be sent. The sync trap message, which carries alarm information for the synchronization, is transmitted after the sync response message is transmitted. The sync trap message includes the sync session ID so that the alarm receiver can identify the message for the synchronization.

The alarm information storage 207 stores alarm information based on the occurrence and the release of the error conditions, and outputs the alarm information under the control of the controller 201. The communicator 209 interfaces to communicate with the alarm receiver; that is, converts a physical signal.

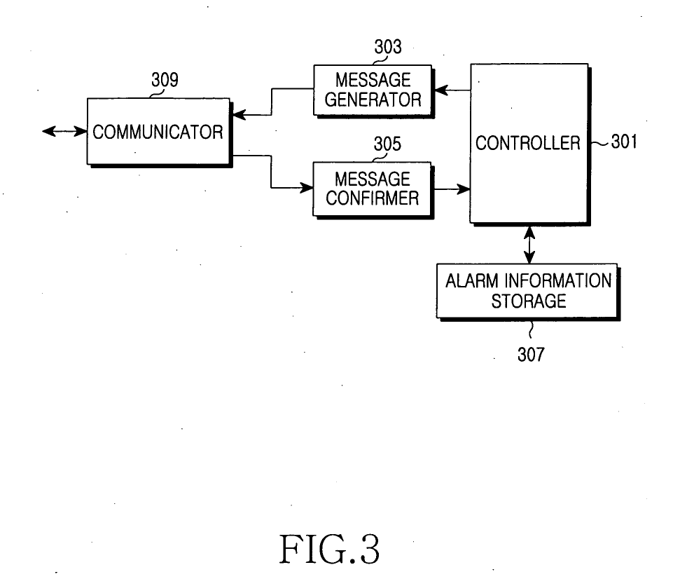

FIG. 3 is a block diagram of the alarm receiver in the fault management system according to an embodiment of the present invention.

The alarm receiver of FIG. 3 includes a controller 301, a message generator 303, a message confirmer 305, an alarm information storage 307, and a communicator 309.

The controller 301 controls overall operation of the alarm receiver. For example, the controller 301 inquires the alarm information of the alarm sender and controls to collect alarm information from a plurality of alarm senders. In the embodiment of the present invention, when determining the necessity of the alarm information synchronization, the controller 301 controls sending a sync request message to the corresponding alarm sender. For example, if the serial numbers of the received trap messages are not consecutive, the controller 301 determines the necessity of the alarm information synchronization. The controller 301 updates the alarm information about the corresponding alarm sender based on the sync trap message received for the synchronization.

The message generator 303 generates a message to be sent to the alarm sender. Particularly, the message generator 303 generates a sync request message. The message confirmer 305 confirms a message received from the alarm sender. In the embodiment of the present invention, the message confirmer 305 confirms the sync session ID and the number of the sync trap messages to be received in the sync response message received after the synchronization request. The message confirmer 305 distinguishes the sync trap message from the received trap messages using the sync session ID and provides the sync trap message to the controller 301.

The alarm information storage 307 stores alarm information collected from the plurality of the alarm senders. The communicator 309 interfaces to communicate with the alarm sender; that is, converts the physical signal.

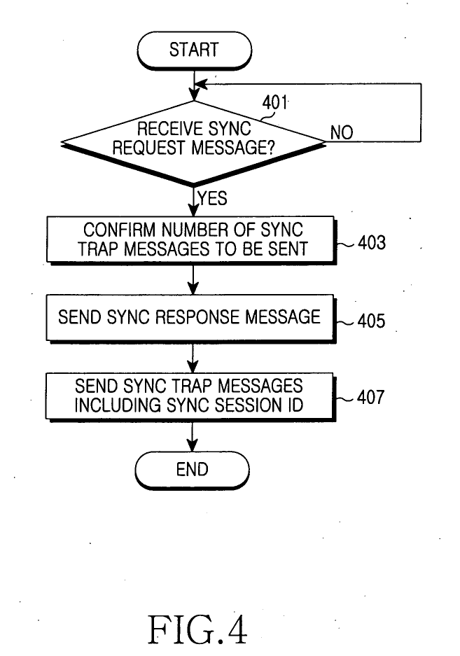

FIG. 4 illustrates a synchronization method of the alarm sender in the fault management system according to an embodiment of the present invention.

The alarm sender checks whether a sync request is defined for the alarm synchronization.

Upon receiving the sync request message, the alarm sender confirms the number of the sync trap messages to be sent in step 403. Namely, the alarm sender confirms the number of the alarm information to be sent. Herein, alarm information to be sent are the one or more alarm information which have been stored when the sync request message is received.

In step 405, the alarm sender sends a sync response message. Herein, the sync response message is defined for the alarm synchronization and includes the information relating to the sync session ID and the number of the sync trap messages to be sent, which will be included in the sync trap message.

In step 407, the alarm sender sequentially sends the sync trap messages including the sync session ID.

When an alarm occurs between the reception of the sync request message in the step 403 and the transmission of the sync trap message in step 407, the alarm sender does not send the trap message. To accurately synchronize the alarm information, the trap message about the alarm occurring in the steps 403 through 407 is buffered and then transmitted after the synchronization is completed.

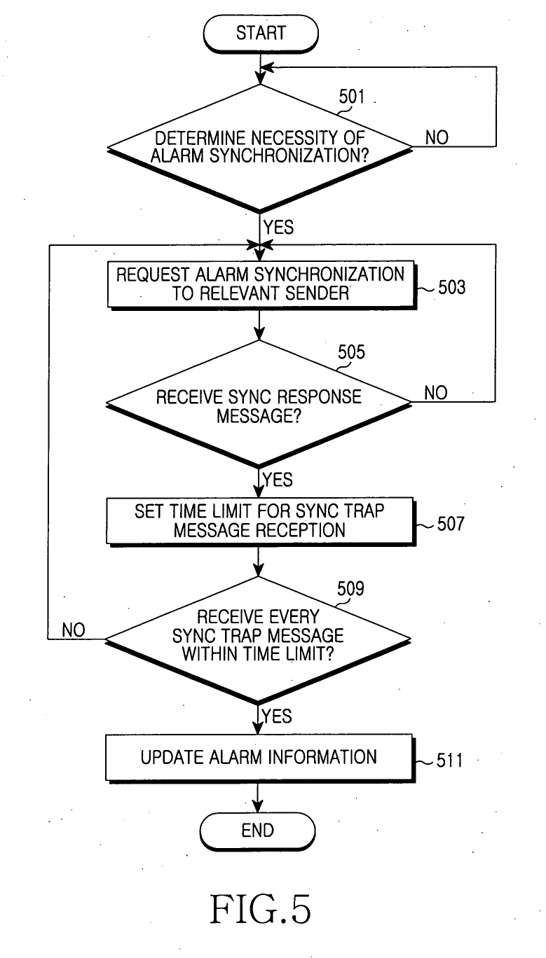

FIG. 5 illustrates a synchronization method of the alarm receiver in the fault management system according to an embodiment of the present invention.

The alarm receiver determines the necessity of the alarm synchronization in step 501. For instance, when the serial numbers in the trap messages are not consecutive, the alarm receiver determines the necessity of the alarm synchronization.

Upon determining the necessity of the alarm synchronization, the alarm receiver requests an alarm synchronization with the relevant alarm sender in step 503. That is, the alarm sender sends a sync request message to the relevant alarm sender. Herein, the sync request message is defined for the alarm synchronization.

In step 505, the alarm receiver checks whether a sync response message is received from the alarm sender. Herein, the sync response message is defined for the alarm synchronization. The sync response message includes the information relating to the sync session ID and the number of the sync trap messages to be received, which will be included in the sync trap message.

When no sync response message is received over a certain time period, the alarm receiver goes back to step 503.

By contrast, receiving the sync response message, the alarm receiver sets a time limit for the reception of the sync trap message in step 507. Herein, the time limit is set using the information relating to the number of the sync trap messages in the sync response message.

In step 509, the alarm receiver checks whether all of the sync trap messages are received within the set time limit. The alarm receiver checks whether as many the sync trap messages as the number included in the sync response message are received within the set time limit. Herein, the sync trap message includes the sync session ID confirmed from the sync response message. Accordingly, the alarm receiver can distinguish the sync trap message from the general trap message using the session ID.

After receiving every sync trap message within the time limit, the alarm receiver updates the alarm information in step 511.

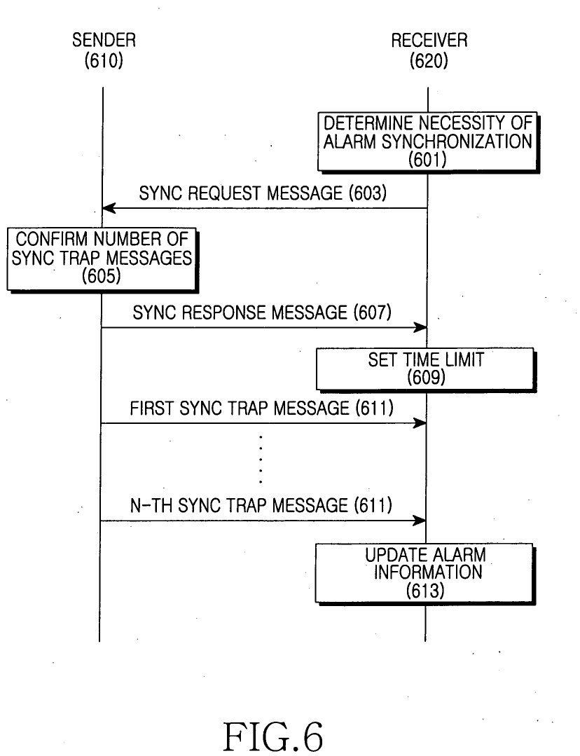

FIG. 6 is a diagram of signal exchanges between the alarm sender and the alarm receiver in the synchronization of the fault management system according to an embodiment of the present invention.

The receiver 620 determines the necessity of the alarm synchronization in step 601. The receiver 620 determines that the serial numbers of the trap messages are not consecutive.

Next, the receiver 620 sends a sync request message to the sender 610 in step 603.

The sender 610, receiving the sync request message, confirms the number of the sync trap messages to be sent in step 605. That is, the sender 610 confirms the number of the alarm information to be sent.

In step 607, the sender 610 sends the sync response message to the receiver 620. Herein, the sync response message includes the information relating to the number of the sync trap messages confirmed in the step 605 and the sync session ID.

Upon receiving the sync response message, the receiver 620 sets the reception time limit of the sync trap messages in step 609. Herein, the time limit is set by referring to the number of the sync trap messages in the sync response message.

In step 611, the sender 610 sends all of the sync trap messages in sequence.

The receiver 620, receiving every sync trap message within the time limit, updates the alarm information in step 613.

As set forth above, the fault management system synchronizes the alarm information using the sync trap message. Therefore, the accuracy of the alarm information synchronization can be ensured without limiting amount of the alarm information and the protocol in use.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. An alarm sending apparatus in a fault management system comprising:
a confirmer for checking whether a synchronization (sync) request message is received;
a controller for providing one or more alarm information to be synchronized and a sync session identifier to a generator;
the generator for generating one or more sync trap messages including the sync session ID; and
a communicator for sending the message generated at the generator.

2. The alarm sending apparatus of claim 1, wherein the controller provides the generator with the one or more alarm information which have been stored when the sync request message is received.

3. The alarm sending apparatus of claim 1, wherein the controller controls sending a trap message which is generated between a first time point when the sync request message is received and a second time point when the one or more sync trap messages are completely transmitted, after the sync trap message is sent.

4. The alarm sending apparatus of claim 1, wherein the generator generates a sync response message which comprises the sync session ID and information relating to a number of one or more sync trap messages to be sent.

5. The alarm sending apparatus of claim 1, wherein the generator generates a message according to a Simple Network Management Protocol.

6. An alarm receiving apparatus in a fault management system comprising:
a generator for generating a synchronization (sync) request message;
a communicator for sending the sync request message;
a confirmer for confirming one or more sync trap messages which comprise a sync session identifier; and
a controller for updating alarm information using the one or more sync trap messages.

7. The alarm receiving apparatus of claim 6, wherein the confirmer confirms a sync response message which comprises the sync session identifier and information relating to a number of one or more sync trap messages to be received.

8. The alarm receiving apparatus of claim 7, wherein the controller sets a time limit for a reception of the one or more sync trap messages by referring to the information relating to the number of the one or more sync trap messages.

9. The alarm receiving apparatus of claim 8, wherein the controller, when the reception of the one or more sync trap messages is not completed within the time limit, controls resending the sync request message.

10. The alarm receiving apparatus of claim 6, wherein the controller, when serial numbers of the received trap messages do not sequentially increase, controls sending the sync request message.

11. The alarm receiving apparatus of claim 6, wherein the generator generates a message according to a Simple Network Management Protocol.

12. A synchronization method of an alarm sender in a fault management system, the method comprising:
checking whether a synchronization (sync) request message is received;
confirming one or more alarm information to be synchronized and a sync session identifier; and
sending one or more sync trap messages which comprise the sync session identifier.

13. The synchronization method of claim 12, wherein the one or more alarm information to be synchronized are one or more alarm information which have been stored when the sync request message is received.

14. The synchronization method of claim 12, further comprising:
checking whether a new trap message is generated between a first time point when the synch request message is received and a second time point when the one or more sync trap messages are transmitted; and
sending the new trap message after the sync trap messages are transmitted.

15. The synchronization method of claim 12, further comprising:
sending a sync response message which comprises the sync session identifier and information relating to a number of one or more sync trap messages to be sent.

16. The synchronization method of claim 12, wherein the sync trap message conforms to a Simple Network Management Protocol.

17. A synchronization method of an alarm receiver in a fault management system, the method comprising:
sending a synchronization (sync) request message;
checking whether one or more sync trap messages comprising a sync session identifier are received; and
updating alarm information using the one or more sync trap messages.

18. The synchronization method of claim 17, further comprising:
checking whether a sync response message comprising the sync session identifier and information relating to a number of one or more sync trap messages to be received, is received.

19. The synchronization method of claim 18, further comprising:
setting a time limit for the reception of the one or more sync trap messages by referring to the information relating to the number of the one or more sync trap messages.

20. The synchronization method of claim 19, further comprising:
resending the sync request message when the reception of the one or more sync trap messages is not completed within the time limit.

21. The synchronization method of claim 17, further comprising:
sending the sync request message when serial numbers of the received trap messages do not sequentially increase.

22. The synchronization method of claim 17, wherein the sync trap message conforms to a Simple Network Management Protocol.
